(19) United States
(12) Patent Application Publication
(10) Pub. No.: US 2024/0324648 A1
(43) Pub. Date: Oct. 3, 2024

(54) Nozzle Height Adjustment Apparatus and Method for an Extruder Assembly

(71) Applicant: Sargento Foods Inc., Plymouth, WI (US)

(72) Inventor: Daniel K. Meyer, Chilton, WI (US)

(21) Appl. No.: 18/191,344

(22) Filed: Mar. 28, 2023

(51) Int. Cl. A23P 30/20; A01J 25/00; A01J 25/12; A23C 19/068

(52) U.S. Cl. CPC A23P 30/20; A01J 25/008; A01J 25/12; A23C 19/0684

(57) ABSTRACT

An apparatus and a method for adjusting the height of a nozzle on an extruder assembly using a height adjuster on the extruder assembly to raise and to lower the nozzle and adapted particularly to the production of products, such as string cheese sticks, having a weight within a target range.

### FIELD OF THE INVENTION

The invention relates to an apparatus and a method for adjusting nozzle height on an extruder assembly and, more particularly, to an apparatus and a method for adjusting nozzle height on an extruder assembly for making products, such as string cheese sticks, with a weight that falls within a target range.

### BACKGROUND OF THE INVENTION

In the making of an extruded product such as string cheese, an extruder is used and the weight of individual sticks of string cheese produced can change during production. Adjustments need to be made to the weight of the sticks of string cheese during production to ensure individual sticks fall within a target range. An operator makes periodic checks of the weight of the string cheese sticks being produced. If the weight falls outside an acceptable range, adjustments need to be made.

Such adjustments to the weight of the sticks of string cheese being produced are traditionally made with the use of a standard floor jack to raise or to lower the entire extruder stand thereby raising or lowering the extruder nozzle. When adjustments to the weight of the string cheese sticks being produced need to be made, an operator needs to locate the floor jack then place it into a proper lifting location relative to the extruder stand. The operator then operates the floor jack to lift the front of the extruder stand off of the floor with the front of the stand being uniformly raised or lowered. The operator makes height adjustments to the feet of the legs of the extruder stand and then lowers the extruder stand back to the floor and removes the floor jack. This lengthy and cumbersome process is then repeated as many times as are necessary during production to maintain the weight of the string cheese sticks being produced within a target range. Such floor jacks typically have a useful life of a few months before they need to be replaced due to corrosion as they are typically made out of steel or aluminum which are not suited for a food or a wash down environment.

Adjustments to the weight of sticks of string cheese during production can also be made by setting up the extruder to be level and then changing the weight of the sticks by changing the length of the sticks at the cutter. The elevation of the extruder is thus not changed. With this method, the sticks of string cheese produced are of varying lengths which is noticeable by a consumer in string cheese packaging.

### SUMMARY OF THE INVENTION

In one construction, the disclosure provides an extruder assembly including an extruder including a nozzle for extruding a product and a stand for supporting the extruder, the stand having a pivot and having a height adjuster adapted to raise and to lower the nozzle by rotating the stand about the pivot to change the weight of the extruded product.

In another construction, the disclosure provides an extruder assembly including an extruder including a nozzle and a stand for supporting the extruder, the stand having at least one pivot and having a height adjuster adapted to raise and to lower the nozzle by rotating the stand about the pivot, wherein the height adjuster is a vernier adjustment height adjuster having a manually operated hand wheel turnable by a user to enable the raising and the lowering of the nozzle.

In another construction, the disclosure provides a method for extruding a product including the steps of extruding a product through a nozzle of an extruder, the extruder including a height adjuster, measuring the weight of the extruded product, if the weight of the extruded product is greater than a target range of weight, raising the height of the nozzle using the height adjuster by rotating the extruder about a pivot and if the weight of the extruded product is less than a target range of weight, lowering the height of the nozzle using the height adjuster by rotating the extruder about the pivot.

In another construction, the disclosure provides a method for height adjustment of an extruder producing a product including the steps of determining a target range for a weight of an extruded product, extruding the product through a nozzle of an extruder assembly, the extruder assembly having an extruder, a scale and having a motorized height adjuster in communication with the scale, measuring the weight of the extruded product using the scale, and if the weight is outside of the target range, sending a communication from the scale to the motorized height adjuster so that the motorized height adjuster automatically raises or lowers the nozzle as needed to change the weight of subsequent extruded products.

Other aspects of the disclosure will become apparent by consideration of the detailed description and accompanying drawings.

### BRIEF DESCRIPTION OF THE DRAWINGS

FIG. 1 is a perspective view of an extruder assembly of the current invention.

FIG. 2 is a side view of the extruder assembly.

FIG. 3 is a front view of the extruder assembly.

FIG. 4 is a front view of a height adjuster on the extruder assembly.

FIG. 5 is a rear view of the extruder assembly.

FIG. 6 is a perspective view of the extruder assembly with a nozzle at an elevated height.

FIG. 7 is a front view of a second embodiment of the extruder assembly.

FIG. 8 is a side view of a third embodiment of the extruder assembly.

### DETAILED DESCRIPTION OF THE INVENTION

Before any constructions of the disclosure are explained in detail, it is to be understood that the disclosure is not limited in its application to the details of construction and the arrangement of components set forth in the following description or illustrated in the following drawings. The disclosure is capable of other constructions and of being practiced or of being carried out in various ways.

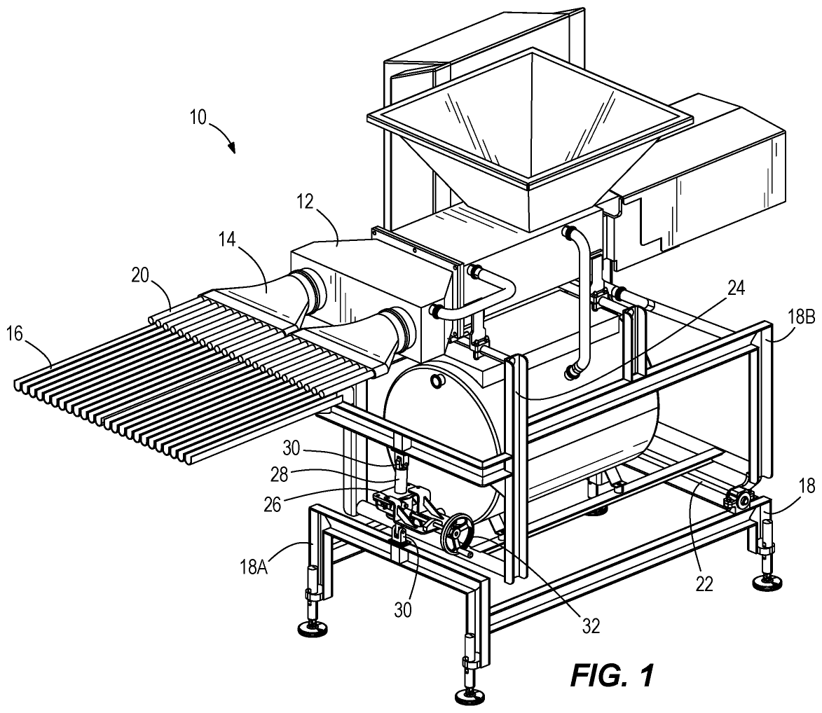

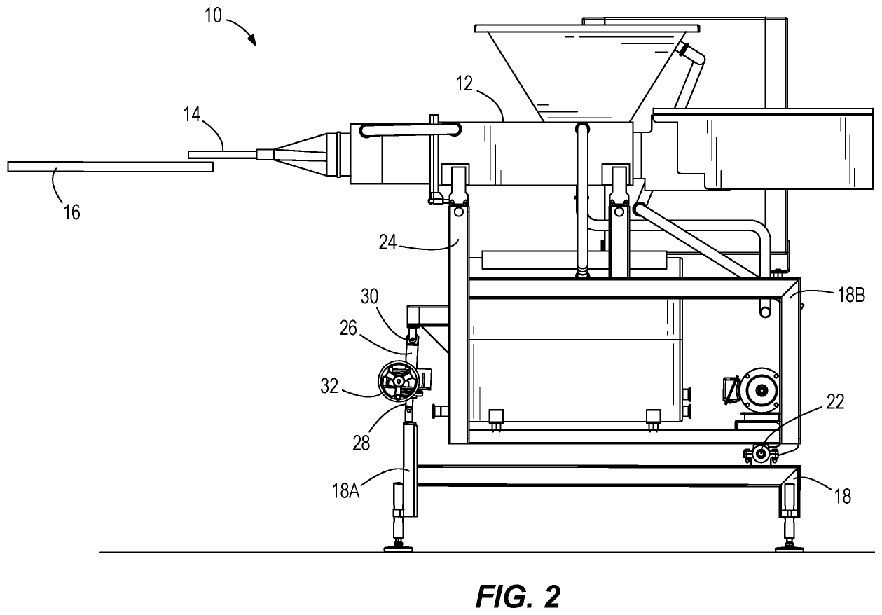

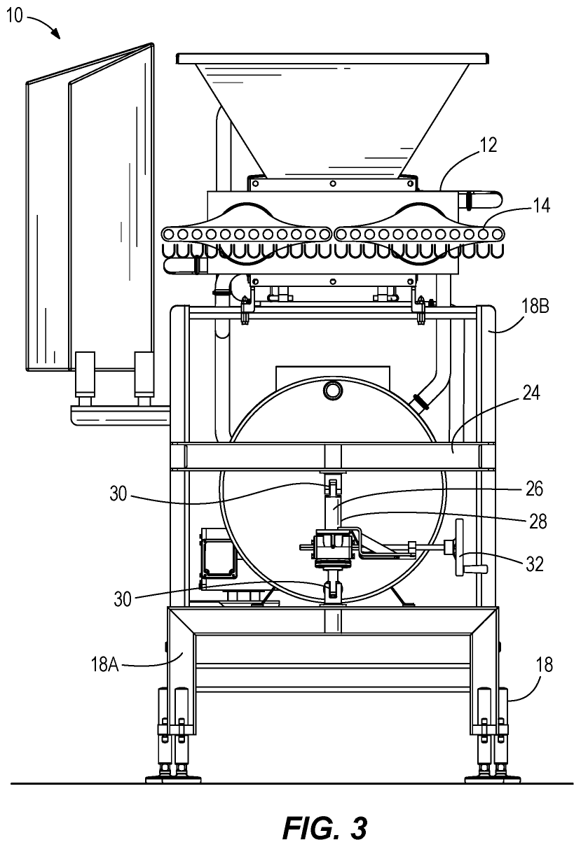

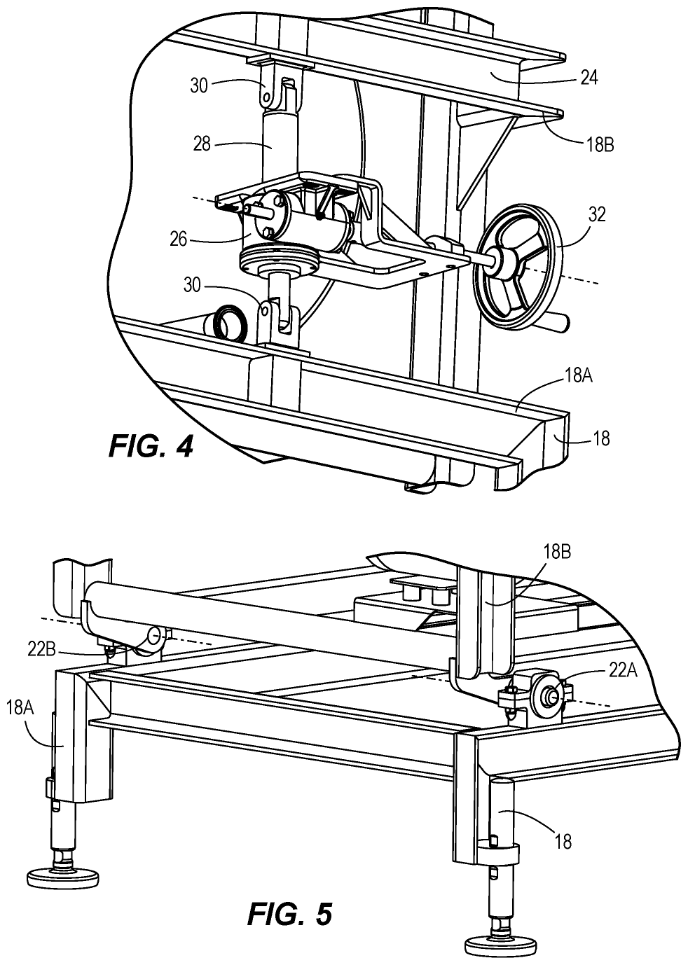

FIGS. 1-6 illustrate an extruder assembly 10 of the present invention. The extruder assembly 10 includes an extruder 12 having an extruder nozzle or nozzles 14 and a takeaway trough 16, as are known in the art. The extruder assembly 10 includes a stand 18. The stand 18 preferably has two sections including a stationary bottom section 18A and a movable top section 18B, however, other configurations can also be utilized. An example of such an extruder and stand is a 10606-900 model extruder available from Koss Industrial Inc. The nozzle 14 extrudes a product 20 with a target range for weight. The product 20 can be any type of product that needs to be manufactured within a target range. For example, the extruder assembly 10 shown can be used in a production line to produce string cheese sticks, however, other products such as taffy, caramel and the like for example can also be produced with the extruder assembly 10.

The extruder assembly 10 includes a pivot 22 on the stand 18 for enabling one end 24 of the top section 18B of the stand 18 to be of the rotatably moved upwardly and downwardly about the pivot 22 with the bottom section 18A remaining stationary. The stand 18 can include a single pivot or a plurality of pivots. As is shown in the drawing, two pivots 22A and 22B are shown. The pivot is a captured rotary joint type pivot as is known in the art. However, it should be noted that other types of pivots can be utilized to rotate the stand 18 upwardly and downwardly.

Continuing to refer to FIGS. 1-6, the extruder assembly 10 includes a height adjuster 26 which enables the top section 18B to be rotated about the pivot 22. The height adjuster 26 can be mechanical, electrical or motorized and can be manually or non-manually operated. As shown in the drawings, for example, the height adjuster 26 is a mechanical device providing a vernier adjustment such as a jack screw 28 and is secured to the stand 18 with clevises 30. A hand wheel 32 is operationally connected to the jack screw 28 so that a user such as an operator can manually increase or decrease the nozzle 14 height depending upon the rotation of the top section 18B about the pivot 22. The height adjuster 26 is preferably fabricated from stainless steel to extend its useful life in particular environments, however, other materials can be used as desired.

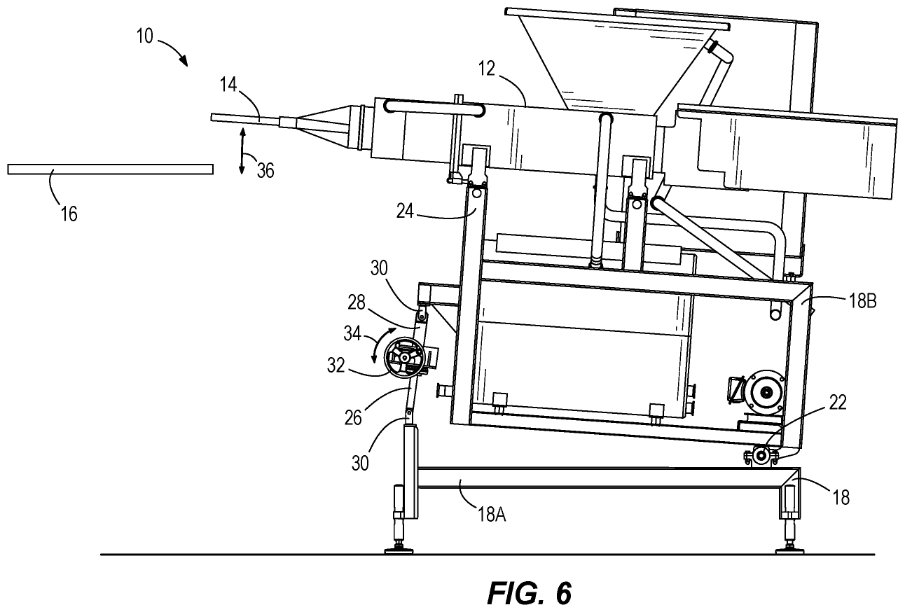

With reference to the production of the product 20, during operation of the production line, an operator will a make periodic checks of the weight of the product 20 produced using a scale. The product 20 produced on the production line will have a determined target range for weight. For example, product 20 such as individual 1 oz. string cheese stick could have target range of weight of 1.0032 oz.-1.0208 oz. If the measured weight of an individual product falls outside of the target range, the operator will adjust the height of the nozzle 14 using the hand wheel 32, raise nozzle 14 elevation to decrease the weight of the products yet to be produced and lower nozzle elevation to increase the weight of the products yet to be produced. To change the elevation of the nozzle 14 and as shown in FIG. 6, the operator turns the hand wheel 32 as shown with arrow 34 appropriately so that the jack screw 28 rotates the top section 18B upwardly or downwardly about the pivot 22 to raise or lower the nozzle 14 as needed and shown with arrow 36. Changing the elevation of the nozzle 14 increases or decreases the stretch of the product material to change the thickness and thus the weight for the same length of product 20.

As the weight of the product 20 changes during production, operators can make the adjustments as needed to keep the weight of the extruded products produced within the target range.

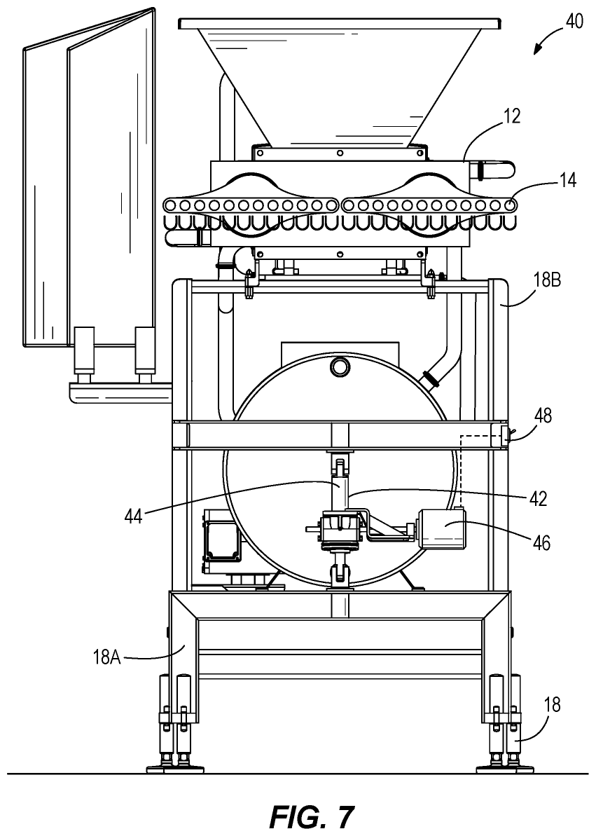

Turning to FIG. 7, a second embodiment of the extruder assembly 40 is shown. In this embodiment, a height adjuster 42 is motorized using a jack screw 44 and a motor 46, and a toggle switch 48 is in communication with the motor 46. When the nozzle 14 needs to be raised or lowered, the operator engages the toggle switch 48 up or down to activate the motorized height adjuster 42 to thus appropriately raise or lower the nozzle 14 height by rotating the top section 18B about the pivot 22 (not shown). It should be noted that other motorized height adjusters other than that shown in the drawings can also be utilized.

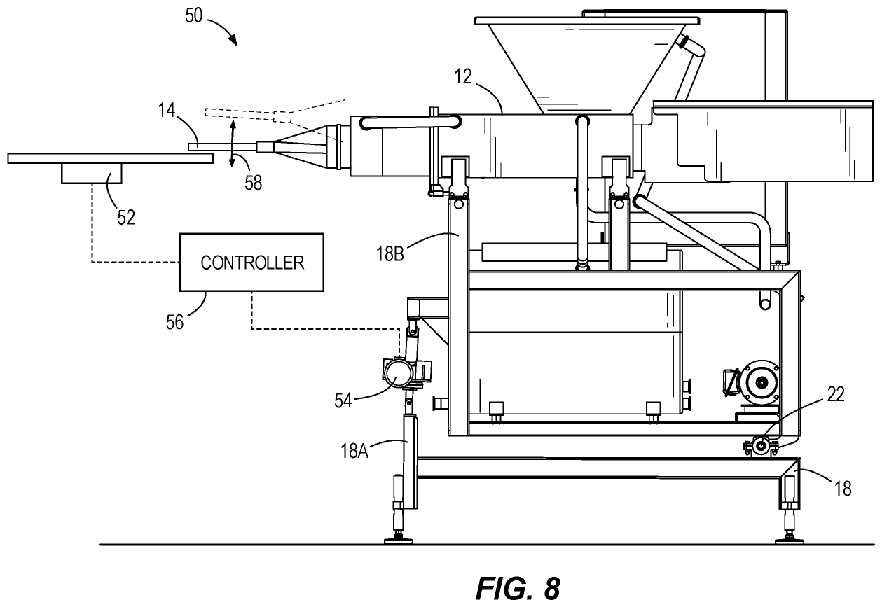

Turning to FIG. 8, a third embodiment of an extruder assembly 50 is shown. In this embodiment, the extruder assembly 50 includes a scale 52 in communication with a motorized height adjuster 54 via a controller 56. A target range for the weight of a product 20 is inputted into the controller 56. The weight of every or select products produced is determined using the scale 52. If the measured weight of a product 20 is outside of the target range, a communication as shown in dashed lines is sent from the scale 52 to the motorized height adjuster 54 by the controller 56 to enable the motorized height adjuster 54 to automatically raise or lower the nozzle 14 as needed and shown with arrow 58 to change the weight of subsequent extruded products 20.

Various features and advantages of the invention are set forth in the following claims.

What is claimed is:

1. An extruder assembly comprising:
an extruder including a nozzle for extruding a product; and
a stand for supporting the extruder, the stand having a pivot and having a height adjuster adapted to raise and to lower the nozzle by rotating the stand about the pivot to change the weight of the extruded product.

2. The extruder assembly of claim 1 wherein the height adjuster is a manual height adjuster.

3. The extruder assembly of claim 1 wherein the height adjuster is a vernier height adjuster.

4. The extruder assembly of claim 1 wherein the height adjuster is a jack screw.

5. The extruder assembly of claim 1 wherein the height adjuster includes a manually operated hand wheel.

6. The extruder assembly of claim 1 wherein the height adjuster is a motorized height adjuster.

7. The extruder assembly of claim 1 wherein the stand includes a top rotatable portion and a bottom stationary portion.

8. The extruder assembly of claim 1 wherein the stand has opposite ends, the pivot is one of the opposite ends and the height adjuster is on the other of the opposite ends.

9. The extruder assembly of claim 1 wherein the stand has a second pivot about which the stand rotates.

10. An extruder assembly comprising:
an extruder including a nozzle; and
a stand for supporting the extruder, the stand having at least one pivot and having a height adjuster adapted to raise and to lower the nozzle by rotating the stand about the pivot,
wherein the height adjuster is a vernier adjustment height adjuster having a manually operated hand wheel turnable by a user to enable the raising and the lowering of the nozzle.

11. The extruder assembly of claim 9 wherein the height adjuster is a jack screw.

12. The extruder assembly of claim 9 wherein the stand includes a first stationary portion and a second rotatable portion and includes two pivots for rotating the upper portion of the stand.

13. A method for extruding a product comprising the steps of:
extruding a product through a nozzle of an extruder, the extruder including a height adjuster;
measuring a weight of the extruded product;
if the weight of the extruded product is greater than a target range of weight, raising the height of the nozzle using the height adjuster by rotating the extruder about a pivot; and
if the weight of the extruded product is less than the target range of weight, lowering the height of the nozzle using the height adjuster by rotating the extruder about the pivot.

14. The method of claim 13 wherein the height adjuster is manually operated by a user.

15. The method of claim 14 wherein the manual operation by the user includes the use of a rotatable wheel.

16. The method of claim 13 wherein the height adjuster includes a jack screw.

17. The method of claim 13 wherein the height adjuster is motorized.

18. A method for height adjustment of an extruder producing a product comprising:
determining a target range for a weight of an extruded product;
extruding the product through a nozzle of an extruder assembly, the extruder assembly having an extruder, a scale and having a motorized height adjuster in communication with the scale;
measuring the weight of the extruded product using the scale; and
if the weight is outside of the target range, sending a communication from the scale to the motorized height adjuster so that the motorized height adjuster automatically raises or lowers the nozzle as needed to change the weight of subsequent extruded products.

19. The method of claim 18 wherein the motorized height adjuster raises and lowers the nozzle by rotating a portion of the extruder assembly about at least one pivot point.

20. The method of claim 18 wherein the extruder assembly further includes a stand supporting the extruder and the motorized height adjuster.
